(19) United States
(12) Patent Application Publication
(10) Pub. No.: US 2004/0110621 A1
(43) Pub. Date: Jun. 10, 2004

(54) Printing machine with flexible folding guide

(76) Inventors: Leonard T. Katilas, Baltimore, MD (US); Michael Cuff, Malmesbury (GB)

Correspondence Address: RONALD B. SHERER, 103 SOUTH SHAFFER DRIVE, NEW FREEDOM, PA, 17349, US

(21) Appl. No.: 10/310,298

(22) Filed: Dec. 5, 2002

(51) Int. Cl. B31F 1/00

(52) U.S. Cl. 493/405

(57) ABSTRACT

A printing machine with a folding section is disclosed in which the folding section includes a folding guide over which sheets of material are folded, and in which the end of the folding guide includes a flexible tip portion to prevent undue folding of a portion of the sheet relative to other portions of the sheet.

### BACKGROUND

Printing machines which are designed to print high quality images on corrugated box or carton blanks also include a folding section in which the blanks are folded so as to later form a box or other container. Corrugated cardboard is difficult to fold, and such folds must be made very precisely or the folded blank must be rejected. In the past, the folding systems have sometimes been prone to prematurely fold one or more of the leading flaps of the box blank as it is conveyed through the folding section of the printing machine such that the folded edges are not square and/or are rolled instead of being flat as is required for an acceptable folded box blank.

### SUMMARY

The present invention solves this serious problem by providing a flexible element which engages the underneath surfaces of the leading flaps of the carton blanks and prevents the leading flaps from folding downwardly prematurely, or to a greater degree than the downward folding movement of the panel portions of the blank to which the flaps are connected.

### BRIEF DESCRIPTION OF DRAWINGS

FIG. 1 is a schematic illustration of a typical printing machine;

FIG. 2 is a schematic illustration of a typical carton blank to be folded;

FIG. 3 illustrates an edge of a box blank in cross-section which has been folded square;

FIG. 4 illustrates an edge of a box blank in cross-section which has been folded with a rolled edge;

FIGS. 5 is a schematic perspective view of a portion of the folding section of the machine;

FIG. 6 is a schematic perspective view of the folding guide of the present invention;

FIGS. 7 is a side elevational view of the folding guide of the present invention; and

FIG. 8 is an enlarged view of the pivoted portion of FIG. 7.

### DETAILED DESCRIPTION

FIG. 1 illustrates a typical printing machine 10 which includes a feed section, one or more stages of printing sections, a scoring/slotting section and a folding section. Typically, the machine is a flexographic printer and prints very high quality images on container blanks 12 which pass successively through the machine by well known conveyor means such as vacuum conveyors.

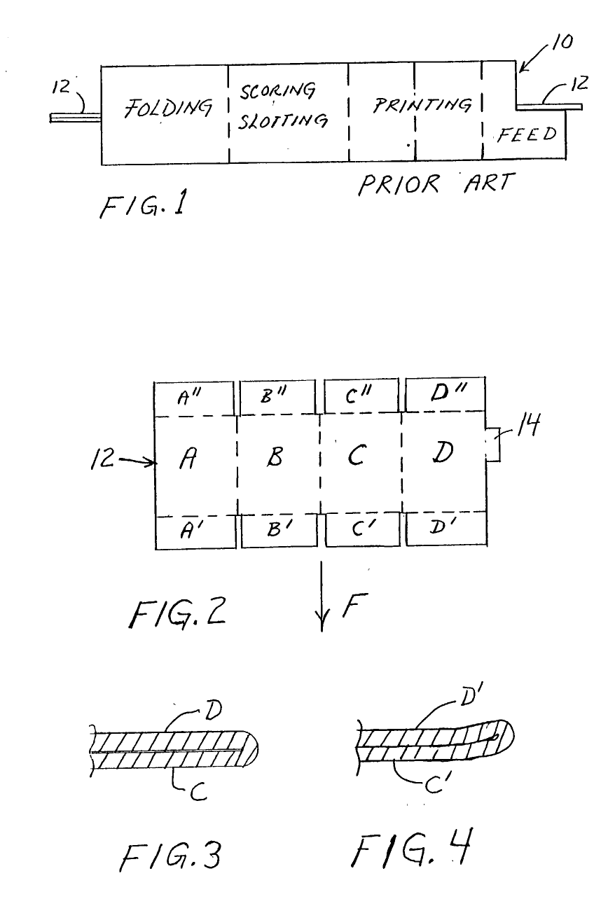

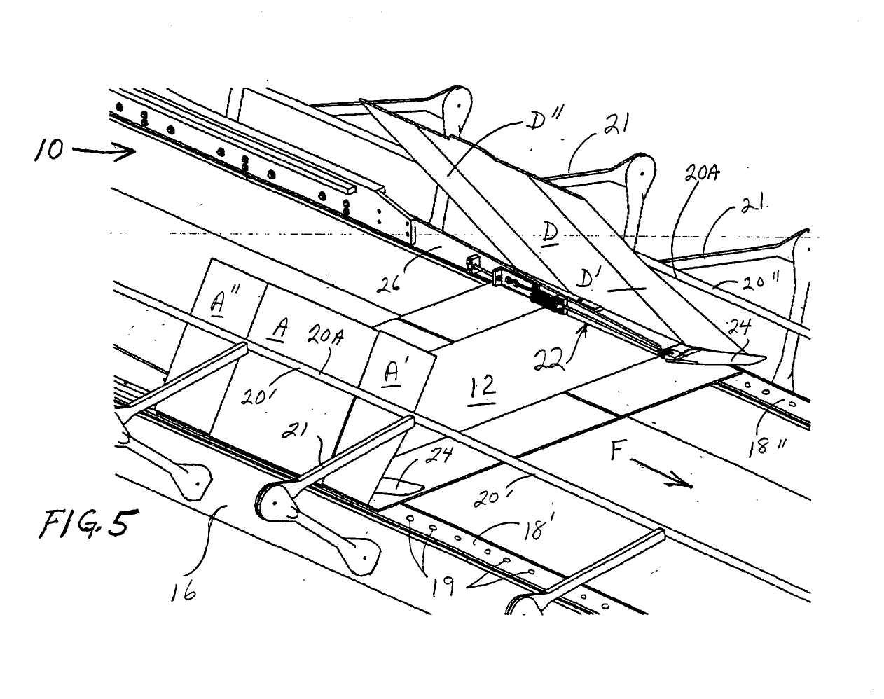

In order to define the terminology used in the art, FIG. 2 illustrates a box or carton blank 12 which is composed of corrugated cardboard and which is to become a container or an end display. The blank comprises an integral corrugated sheet having portions known in the industry as panels A, B, C and D. Each of the panels have leading edge flaps denoted by the letters primed, and trailing edge flaps denoted by the letters double primed. As is well known, the blank is slotted between the flaps and is scored between each of the panels as well as between each panel and its leading and trailing flaps. The object of the folding action is to fold panel A over panel B, and fold panel D over panel C so that glue tab 14 adheres to the edge portion of panel A. This must be done in a manner such as to have the folded blank “square” as this term is used in the industry. For example, being “square” requires that all edges formed at all of the score lines between the panels and between the panels and their respective leading and trailing flaps must be at right angles to each other. Being “square” also requires that no edge is “rolled”. That is, all of the folded panels must be flat and planar as illustrated in FIG. 3, and not curved or rolled as illustrated in FIG. 4. As previously stated, producing each and every folded box blank to be perfectly square is critical to the entire operation lest non-square folded blanks be rejected as very expensive waste.

Referring to FIG. 5 a typical printing/folding machine 10 includes two horizontally extending, spaced-apart side frame members 16 one of which is visible in the lower left portion of the FIG. The frame members support spaced-apart conveyor belts 18′ and 18″, preferably including vacuum holes 19, which convey each blank 12 in the direction of arrow F from the scoring/slotting section to and through the folding section of the machine. The folding section of the machine also includes a pair of spaced-apart folder rods 20′ and 20″. The rods are preferably supported by pivoted supports 21, and each of the rods includes a curved portion 20A which progressively folds panels A and D downwardly as is well known in the folding art.

As shown most clearly in FIG. 5, the rods engage side panels A and D and fold these toward the center of the blank. When this folding action initially takes place, the blank is held down by a pair of elongated folding guides 22 one of which is shown in FIG. 5. The side edges of the folding guides engage the blank at the score lines between panels A and B, and between C and D. Folding the panels over the edges of the guides assists in folding the blank square. However, it sometimes happens that one or other or both of leading flaps A′ and/or D′ are pushed downwardly too early or too far by the folding rods 20′ and/or 20″. For example, as the box blank initially engages the folding rods, the leading flaps A′ and D′ may engage the rods before their respective panel potions A and D engage the rods. Thus, due to warpage or otherwise, one or other of the leading flaps may start to fold downwardly along the score line between the flap and the associated panel before the panel and the flap are folded downwardly together by the rod engaging the panel as well as the flap. In any event, it will be apparent that premature or excessive folding of any of the leading flaps produces a non-square folded blank which is unsatisfactory and must be rejected as waste.

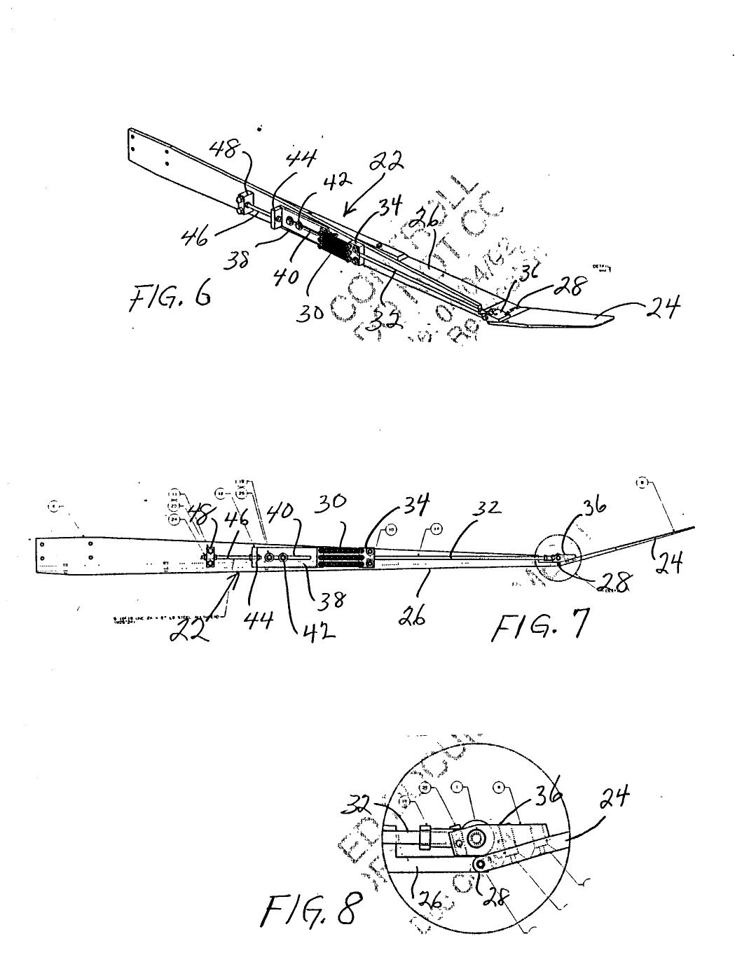

The present invention solves this problem by providing a flexible tip portion 24 at the end of each of the conventional guides 22 as shown in FIGS. 5-8. That is, guide 22 of the present invention includes not only a conventional spear portion 26, but also includes a resilient tip portion 24 which is hinged or pivoted at 28. Tip portion 24 is spring biased to the upper position such as by springs 30 shown in FIGS. 6 and 7. The details of the means connecting the springs to the pivoted tip may vary; however, one preferred embodiment comprises a rod 32 having one end connected to a sliding block 34 which is connected to one end of the springs. The other end of the rod is connected to a clevis 36 which is mounted on the upper surface of tip 24. Thus, the springs constantly bias the tip upwardly and pivoted about point 28 as shown.

If it is desired to adjust the tension of the springs, for different sizes and weights of blanks, the opposite ends of the springs are connected to a slidable bracket 38 having a slot 40. One or more bolts 42 may be used to secure the bracket in the adjusted position for the spring tension desired. While the position of bracket 38 may be adjusted manually for low levels of spring tension, the bracket preferably includes a flange 44 which is connected by a threaded rod 46 to a stationary threaded block 48. Thus, rotation of rod 46 by hand or by a tool in one direction draws slidable bracket 38 to the left and thereby increases the spring tension, while rotation of rod 46 in the opposite direction decreases the tension.

Operation

It will be apparent from the foregoing description of one preferred embodiment of the present invention that flexible tips 24 engage the underneath surfaces of leading flaps A′ and D′ slightly before, or at the same time as, the curved portions of rods 20′ and 20″ engage the upper surfaces of the leading flaps so as to fold them downwardly and simultaneously along with panels A and D. Thus, the leading flaps are prevented from being pushed downwardly more than the amount of the downward movements of panels A and D as they are than engaged by the curved portions of the rods and are pushed downwardly over the side edges of guides 22. Stated otherwise, the upwardly biased resilient tips 24 prevent undesirable and premature downward movement of the leading flaps. Rather, they maintain the leading flaps in planar relationships with their respective panels A and D as the panels and leading flaps are folded downwardly together and simultaneously.

As the blank progresses further in the direction of arrow F in FIG. 5, folding rods 20′ and 20″ continue to push and force the panels and both their leading and trailing flaps downwardly so that panel A overlies panel B and panel D overlies panel C. This progressive downward movement of panels A and D is accommodated by the resilient tips 24 which pivot downwardly against the tension of the springs until the blank clears the ends of the tips. At that time, the tips spring upwardly again to engage the leading flaps of the next blank. As a result, all of the folds are square and the folded edges are not rolled such that virtually no blanks must be rejected as waste product.

From the foregoing description it will be apparent that many modifications and variations of the invention will become apparent to those skilled in the art. Accordingly, it is to be understood that the foregoing description of one preferred embodiment is intended to be illustrative rather than exhaustive of the principles of the invention, and that the scope of the invention is not intended to be limited other than as set forth in the following claims interpreted under the Doctrine of Equivalents.

What is claimed is:

1. A printing machine having a printing section and a folding section for printing on and folding blanks, the blanks including panels and leading flap portions connected to said panels, comprising:
(a) a printing section;
(b) a folding section;
(c) said folding section including horizontally extending curved folding rods and horizontally extending folding guides; and
(d) said folding guides including resilient end portions for engaging the leading flap portions of the panels so as to prevent said leading flap portions from being folded too excessively or too prematurely relative to the folding of their respective panels.

2. The printing machine of claim 1 wherein said resilient end portions are biased upwardly against said flap portions so as to be progressively depressed as the blank passes over said folding guide.

3. The printing machine of claim 1 wherein said resilient end portions are pivotally connected to said guides.

4. The printing machine of claim 3 wherein said resilient end portions are biased upwardly by biasing means.

5. The printing machine of claim 4 wherein said biasing means comprise spring means.

6. Apparatus for folding blanks composed of corrugated cardboard and having panel portions and connected flap potions, comprising:
(a) conveyor means for conveying said corrugated blanks in a first direction;
(b) curved means for engaging the upper surfaces of some of said panel and flap portions of the blanks for folding said portions downwardly as said blanks move in said first direction;
(c) guide means for engaging and holding some of said panels downwardly; and
(d) said guide means including flexible tip portions for engaging the lower surfaces of said flap portions for preventing excessive downward movement of said flap portions by said curved means.

7. The folding apparatus of claim 6 wherein said flexible tip portions are pivotally connected to said guide means.

8. The folding apparatus of claim 6 including spring means for biasing said flexible tip portions upwardly.

9. The folding apparatus of claim 8 including means for varying the tension of said spring means.

10. The folding apparatus of claim 8 including an elongated rod connected at one end to said spring means and connected at the other end to said flexible tip portions.
